(19) United States
(12) Patent Application Publication
(10) Pub. No.: US 2005/0081118 A1
(43) Pub. Date: Apr. 14, 2005

(54) System and method of generating trouble tickets to document computer failures

(75) Inventors: Richard W. Cheston, Morrisville, NC (US); Daryl Carvis Cromer, Apex, NC (US); Richard Alan Dayan, Raleigh, NC (US); Howard Jeffrey Locker, Cary, NC (US)

Correspondence Address: LALLY & LALLY, L.L.P., P. O. BOX 684749, AUSTIN, TX, 78768-4749, US

(73) Assignee: International Business Machines Corporation;, Armonk, NY (US)

(21) Appl. No.: 10/683,242

(22) Filed: Oct. 10, 2003

(51) Int. Cl. G06F 11/00

(52) U.S. Cl. 714/47

(57) ABSTRACT

A data processing system service includes enabling the system to perform diagnostic processing in response to a system failure and enabling the system to perform corrective action during the automated diagnostic processing to attempt to resolve the system failure. The service further includes configuring the system to generate a trouble ticket containing information characterizing the system failure and any attempted corrective action regardless of whether the corrective action was successful in resolving the system failure. The system may be further enabled to forward the trouble ticket to an external database for analysis and to access the external database to determine whether the detected failure has been encountered previously. The system may be partitioned into two partitions including a diagnostic partition. The system boots to the diagnostic partition following a failure or in response to a request from a user.

### BACKGROUND

1. Field of the Present Invention

The present invention is in the field of data processing systems and more particularly in the area of managing data processing system failures.

2. History of Related Art

In the field of data processing systems, automating the management of client systems is a critical factor in reducing total cost of ownership for a customer. Autonomic repair of failed systems is a significant part of automated client management. The goal of autonomic repair is to fix problems when they occur without requiring user intervention and, perhaps more significantly, without initiating a help desk phone call or a field service event. Currently, when a failed system that cannot be fixed through an automated process or with simple user intervention is encountered, a help desk call is initiated. The help desk can attempt to guide the user through a series of diagnostic steps in an attempt to fix or identify the problem more precisely. If the help desk call does not resolve the problem, the help center may send new parts, a new computer or possibly even a field service technician to the user's site depending on the nature and severity of the problem.

Manufacturers and providers of computers and related services are interested in maintaining information regarding the frequency and types of failures that occur on their systems. Typically, however, the data that gets reported is skewed in favor of events that require help desk intervention, field service intervention, or both. More specifically, because there may be a number of problems that are corrected by the system before a help desk call is ever initiated, the sample of help desk calls may not be representative of the types and respective frequencies of failure modes that are occurring in the field. It would be desirable to implement a method and system that enabled data processing providers to monitor and analyze the mechanisms that most frequently cause their systems to fail, regardless of whether those failures ultimately require a help desk call or the like. It would be further desirable if the implemented solution did not significantly increase the cost or complexity of owning and/or operating the corresponding data processing systems.

### SUMMARY OF THE INVENTION

The goals described above are achieved in large part according to one embodiment of the present invention by enabling a data processing system and network to log not just failures that require external intervention, but also those that may be fixed or repaired locally with or without user intervention. In one embodiment, a customer's data processing system is configured with at least two boot images. The first boot image includes the system's normal operating system while the second boot image includes an automated debug or diagnostic routine. If a system failure, such as an OS crash, occurs, the system may be booted into the diagnostic mode. A diagnostic program appropriate for the system is then executed and data indicating the results of various diagnostic tests are recorded. The diagnostic tool may then determine whether the detected problems, if any, may be corrected locally. If the problems can be addressed locally, the system may invoke automated corrective action to attempt to repair the system. The automated corrective action could include actions such as rebooting the system and downloading one or more pieces of computer software (e.g., software drivers), restoring the image to a known good state, or accessing a knowledge database for previous fixes for similar problems.

Regardless of the action that is ultimately taken in response to the diagnostic program, whether it includes a help desk call or other external event, a trouble ticket is generated to document information pertaining to the failure. The trouble ticket is then forwarded to and stored in a database of trouble ticket information that can then be analyzed to determine information including the types of failures that are occurring most frequently and the efficiency of the debug program in correcting failures locally. The invention according to one embodiment is implemented as a service provided by one or more third parties. In this embodiment of the invention, a provider of data processing goods and/or services provides a customer the automated diagnostic code and then receives and monitors the trouble tickets being generated by the system to guide the provider in modifying the automated software to further reduce help center calls and or field service events, advising the customer on changes that can be made to improve system availability, or a combination thereof.

### BRIEF DESCRIPTION OF THE DRAWINGS

Other objects and advantages of the invention will become apparent upon reading the following detailed description and upon reference to the accompanying drawings in which:

FIG. 1 is a block diagram of selected elements of a data processing network used in conjunction with one embodiment of the present invention;

FIG. 2 is a flow diagram of a method of autonomic failure repair in a data processing system according to one embodiment of the invention;

FIG. 3 is a flow diagram emphasizing the provision of autonomic failure correction and analysis services to a customer using the data processing system and network of FIG. 1; and

FIG. 4 is a flow diagram illustrating the configuration of a data processing system of FIG. 1 in accordance with one embodiment of the invention to emphasize the system's ability to boot into an automated diagnostic mode following a system failure.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

Generally speaking, the present invention contemplates systems and methods for employing automated or autonomic failure management of data processing systems. A customer's data processing systems are configured to include at least two boot images (i.e., at least two modes of operation following a system reset and or system power on). A first boot image represents the system's conventional operating system (OS) while the second boot image is a diagnostic image that is invoked following a system failure. The diagnostic image is configured to run a diagnostic program on the system to obtain information about the cause of the failure and to attempt to take corrective action. The corrective action may be automatic, may require user input, or may be a combination of both. The diagnostic program generates a record (referred to herein as a trouble ticket) that includes information about the cause of the problem that caused the system to fail. It is also possible that the diagnostic program may query the user for information about the failure to help determine what the correct corrective action is. In an important aspect of the invention, the diagnostic program is configured to generate trouble tickets for events that require additional support (such as a help desk call or field service call) as well as events for which corrective action was successful. By providing trouble tickets for events that are fixed automatically as well as for events that require additional support, the invention improves the ability of a service provider and its customer to determine the types of events that are occurring on the system as well as the efficiency of the automated software designed to correct failures when they occur.

Turning now to the drawings, selected elements of a representative data processing network 100 on which the present invention might be beneficially employed is depicted. The depicted network includes a local area network (LAN) 102 connected through a gateway device 130 to a wide area network (WAN) 106. Also shown is an external server 140 and database 142 connected to WAN 106 via which an external provider may install, configure, or otherwise provide automated data processing repair functionality to LAN 102.

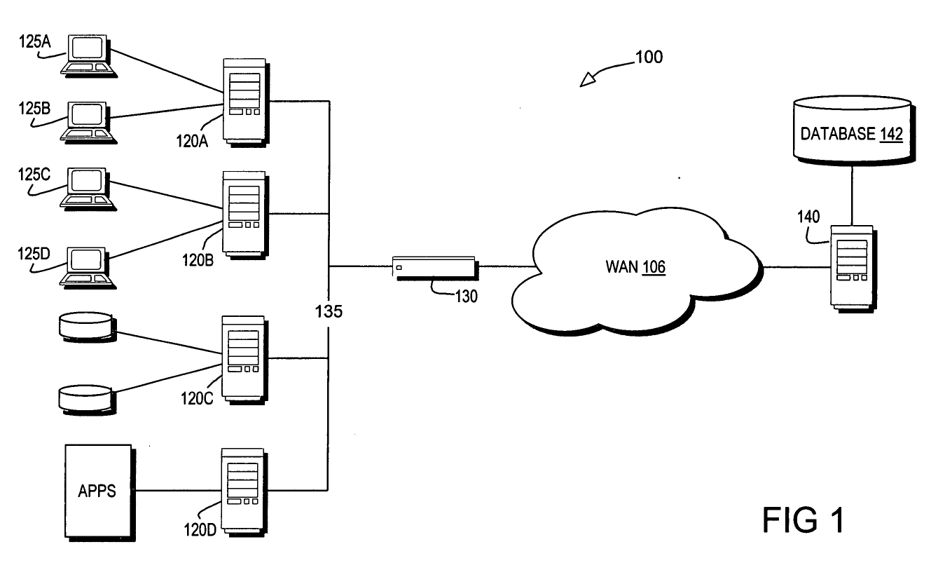

In the depicted embodiment, LAN 102 is representative of an enterprise's data processing network. LAN 102 includes a set of servers 120A through 120D (generically or collectively server(s) 120) to which various devices and systems are connected. Servers 120A and 120B are both connected to a set of data processing systems 125A through 125D. Each data processing system 125 represents a microprocessor-based data processing system such as a desktop or notebook personal computer, a network computer, and so forth. LAN 102 is also shown as including a server 120C connected to disk storage of the network, and an application server 120D that provides applications 132 accessible to data processing systems 125. The set of servers 120 are shown as connected to a gateway device 130 over a network medium 135. LAN 102 and network medium 135 may be implemented as and compliant with an Ethernet network as specified in IEEE Std. 802.3. The configuration of FIG. 1 is, of course, merely an illustration of a possible representative network useful for describing aspects of the present invention. Those skilled in the design of local area networks and enterprise systems will recognize that the inventive concepts described below may be applied to other configurations with equivalent effect.

Substantial portions of the present invention may be implemented as a set or sequence of computer executable instructions (i.e., computer software). In such embodiments, the software may be stored on any of a variety of computer readable media including, as examples, magnetic disks and or tapes, floppy drives, CD ROM's, flash memory devices, ROM's and so forth. During periods when portions of the software are being executed, the instructions may also be stored in the system memory (DRAM) or internal or external cache memory (SRAM).

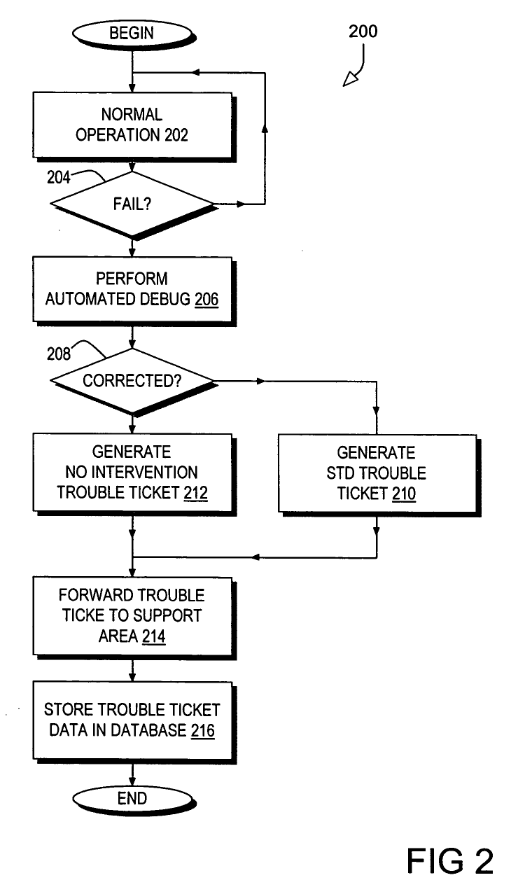

Referring now to FIG. 2, a flow diagram illustrating selected elements of a method 200 of performing automated failure analysis on a data processing system such as one of the data processing systems 125 of FIG. 1 is presented. In the depicted embodiment, method 200 includes an initial block (block 202) in which a representative data processing system 125 is functional and executing in its normal operating state.

System 125 remains in this normal operational state until a failure is detected (block 204). The failure detected in block 204 is typified by an operating system crash or failure that renders the system fully or substantially nonfunctional. Other failures that may be detected in block 204 include hardware interrupts generated by various components of the system. When a failure is detected in block 204, system 125 enters or invokes (block 206) an automated debug routine or agent. It is also possible that the user may decide system 125 is not working correctly and manually start the automated debug routine or agent.

One embodiment of the invention relies on the existence of a bootable debug or diagnostic routine stored in system BIOS, a bootable device such as a CD, and/or a protected area of the hard drive on system 125. This bootable debug routine is invoked following a system failure. In this embodiment, as illustrated in greater detail by the flow diagram of FIG. 4, system 125 is configured, either by the customer or by a third party service provider, with dual boot images. The first boot image represents the system's normal operating system while the second image is the automated debug routine.

In the embodiment depicted in FIG. 4, system 125 monitors for or detects (block 402) the occurrence of a system reset. When a reset is detected, system 125 then determines (block 404) whether a fail flag or some other suitable indicator of a system failure has been set. If the fail flag is set, system 125 boots itself to an automated debug configuration (block 406). If the fail flag is not set, thereby indicating that the power reset was not caused by a system failure, system 125 boots (block 408) its normal operating system image and normal operation continues until a subsequent reset is observed. It is also possible for the user to force the system to boot to an automated debug configuration. This can be done in various ways including have the user set the fail flag, and or have boot menu which allows the user to choose, or have a key sequence at power on that forces a boot to the automated debug configuration.

After booting a failed system into its automated debug image in block 406, the automated debug code is executed (block 410). The automated debug program may perform various system diagnostic routines and may then attempt to take corrective action (block 412). This corrective action may include performing an auto shutdown and reboot, removing code sections suspected of containing a virus, checking system configuration and resolving any configuration conflicts, running a comprehensive system diagnostic routine, defragmenting the system's hard drive, restoring the hard drive to a known good state, and/or detecting modification of network settings. The restoration of a drive to a known good state may be facilitated using a restoration utility such as Rapid Restore PC as an example. The program may also query the user for information about the failure and use this information to guide the user on a potential fix and or determine a fix from a knowledge database.

Following any corrective action efforts taken by system 125, a “trouble ticket” is generated (block 414). Trouble ticket 414 includes information concerning the time and cause of the failure, serial number or other tracking information about the system, the nature of the corrective action taken, and the success or failure of the corrective action. Importantly, it is observed that the trouble ticket is generated by system 125 regardless of whether the any corrective action taken by system 125 was successful. Therefore, even when corrective action is effective in resolving the problem that caused the failure, a trouble ticket is generated nevertheless to document the occurrence of the correctable failure and the means by which the successful repair was achieved.

The generated trouble ticket is then forwarded to a system support/system help area. This system support area is represented in FIG. 1 by an external server 140 and database 142. In other embodiments, the trouble ticket information is stored locally either on the failing system itself or somewhere within the LAN's storage. Local storage of information may beneficially assist the automated debug agent during subsequent debug efforts. If, for example, a system fails a particular test that it has failed previously, local storage of the trouble ticket information may assist the automated debug agent in determining whether the failure has occurred previously and, if so, what actions were previously effective in resolving the problem. This information can be used to prioritize the actions taken to resolve the current conflict. In this manner, local storage of trouble ticket information might enable a system to perform the appropriate corrective before taking time consuming corrective action that did not resolve a similar problem on a prior occasion. It is also possible that the local database may be updated on a regular basis with the server copy thereby achieving the benefits of all problem fixes for all systems similar to it. In the client space it is possible for millions of similar systems to exist so the probability is high that a similar system had a similar problem previously and that the corrective action is known and stored in the database.

If the corrective action taken by the automated debug procedure was effective in resolving the failure, as determined in block 416, the system is rebooted (block 420) into its normal operating system and normal execution is resumed. If corrective action fails to resolve the cause of the problem, the system is presumably down and/or running at a non optimal state (block 418) until the help center is able to resolve the problem either by sending corrective software, sending replacement parts, or initiating a field service call if appropriate.

Returning now to FIG. 2, a determination is made (block 208) following execution of the automated debug routine of whether the problem causing system 125 to fail has been corrected. As described above, method 200 includes generating a trouble ticket regardless of whether the failure causing problem remains. If the automated debug routine does not resolve the problem, a “standard” trouble ticket including information about the failure is generated (block 210). If the failure was corrected by the automated debug routine, a “no intervention” trouble ticket is generated (block 212). The no intervention trouble ticket includes, in addition to the source or nature of the failure, the diagnostic corrective action that was effective in resolving the failure and all of the information of a normal trouble ticket.

Regardless of whether any corrective actions taken were successful in resolving the failure, the trouble ticket generated in response to the failure is forwarded (block 214) to a support area (which may be local, external, or both). The trouble tickets are then stored (block 216) in a database of trouble tickets for subsequent analysis. A system administrator may then access and manipulate the database to determine what type of failures are occurring and which corrective action procedures, if any, are useful in resolving failures. As another example, database information may be used to order the corrective action procedures according to the most commonly encountered failures to fix problems faster.

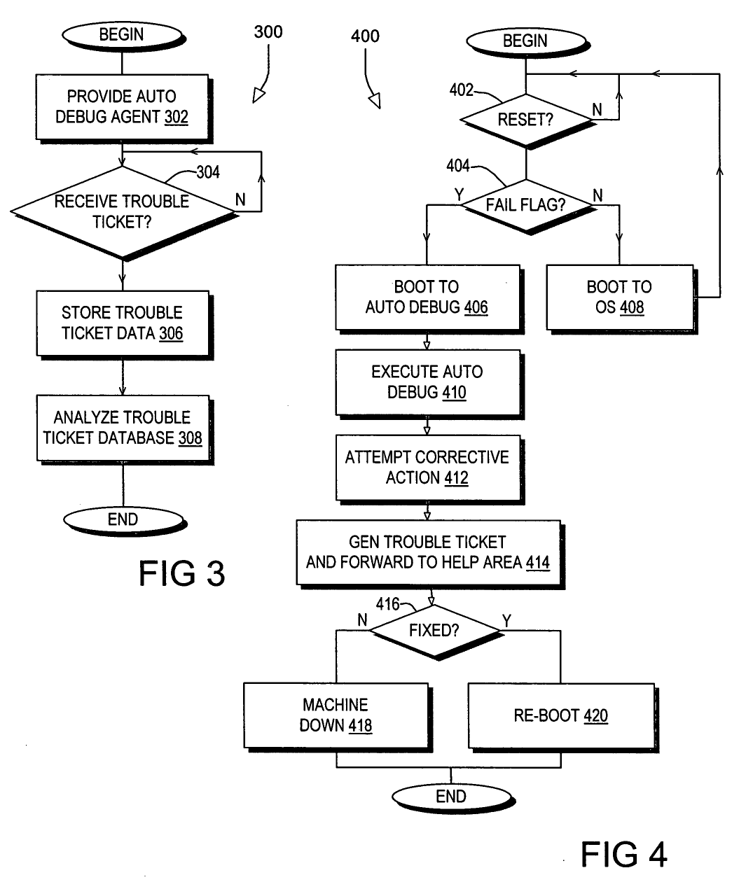

In an embodiment emphasized by the flow diagram of FIG. 3, the present invention is implemented as a service provided to data processing customer by one or more suppliers. More specifically, the flow diagram of FIG. 3 illustrates a method 300 of providing automated diagnostic services to a customer. In the depicted embodiment, the method 300 includes an initial step in which the automated debug agent is provided (block 302) to a customer. The provision of this software may include installation of the software and/or configuration of the customer's system 125 to enter and execute the debug facility properly. In other embodiments, the installation and/or configuration associated with the automated debug routine is performed by the customer. In the embodiment emphasized by the flow diagram of FIG. 3, the provider of the debug functionality is also a provider of debug support services. In this embodiment, the provider is configured to detect (block 304) the receipt of trouble tickets generated by a customer's system.

Referring momentarily back to FIG. 1, the provider of automated debug functionality and services is represented by the external server 140 and the external database 142. As depicted in FIG. 1, external server 140 is accessible to LAN 102 via a wide area network such as the Internet. In this implementation, external server 140 is configured to deliver the automated debug functionality to the system 125 on LAN 102. The delivery of this functionality may be achieved similar to the manner in which BIOS and other firmware updates are made in conventional network attached systems. In other embodiments, the configuration of a system 125 to include the automated debug functionality may require local action such as a local technician or system administrator inserting a CD or other medium into the appropriate system and booting the system. It is also possible to configure the system to add the automated debug functionality natively to the system. This is a one time prep step which can be run from the network or a CD or USB external device. It will set aside a percent of the hard drive and copy the automated debug functionality onto the drive.

Upon detecting the receipt of a trouble ticket, the debug service provider stores (block 306) the trouble ticket information in a database such as database 142 depicted in FIG. 1. The automated debug service provider may then perform analysis (block 308) of the trouble ticket database from time to time to document the predominant failure modes of a customer's systems and to evaluate the utility of various portions of the automated debug routine. As a result of such analysis, the automated debug service provider may modify its automated debug software, e.g., to eliminate portions of the debug that are rarely effective in resolving a problem, to add functionality addressing failure causing modes that are not currently addressed, and so forth. In this manner, the provider of automated debug services, can improve the ability of the customer's data processing systems to detect and correct their own failures thereby improving system availability and reducing system maintenance costs.

It will be apparent to those skilled in the art having the benefit of this disclosure that the present invention contemplates automated failure management for a data processing system. It is understood that the form of the invention shown and described in the detailed description and the drawings are to be taken merely as presently preferred examples. It is intended that the following claims be interpreted broadly to embrace all the variations of the preferred embodiments disclosed.

1. An automated data processing system management service, comprising:
enabling a data processing system to perform diagnostic processing responsive to detection of a system failure;
enabling the system to perform corrective action during the automated diagnostic processing to attempt to resolve the system failure; and
configuring the system to generate a trouble ticket containing information characterizing the system failure and any attempted corrective action regardless of whether the corrective action was successful in resolving the system failure.

2. The service of claim 1, further comprising enabling the data processing system to perform the diagnostic processing responsive to a request from a user suspecting a system failure.

3. The service of claim 1, wherein enabling the system to perform diagnostic processing is further characterized as configuring the data processing system with an operational partition and a diagnostic partition capable of executing the diagnostic processing and configuring the data processing system to boot the diagnostic partition responsive to the system failure.

4. The service of claim 1, further comprising, enabling the system to forward the trouble ticket to an external database.

5. The service of claim 4, wherein enabling the system to perform diagnostic processing and corrective action is further characterized as enabling the system to access the external database to determine whether the detected failure has been encountered previously.

6. The service of claim 4, further configuring the system to permit a user to analyze the external database to determine a characteristic selected from the frequency of various failure modes and the efficiency of the corrective action in resolving failures.

7. The service of claim 1, wherein the diagnostic processing and corrective action include requesting user input to guide the diagnostic processing and corrective action.

8. A computer program product comprising computer executable instructions, stored on a computer readable medium, for diagnosing a data processing system, comprising:
computer code means for performing diagnostic processing responsive to an event selected from a user suspecting a system failure requesting the diagnostic processing and the system detecting a failure;
computer code means for performing corrective action to attempt to resolve the failure; and
computer code means for generating a trouble ticket identifying the system, characterizing the failure, and identifying the correcting action taken and the success of the corrective action, the code means for generating the trouble ticket being executed regardless of the corrective action success.

9. The computer program product of claim 8, further comprising code means for booting a diagnostic partition of the data processing system containing the diagnostic processing code means responsive to the event.

10. The computer program product of claim 8, further comprising, code means for forwarding the trouble ticket to an external database.

11. The computer program product of claim 10, wherein diagnostic processing and corrective action code means include code means for accessing the external database to determine whether the system failure has been encountered previously.

12. The computer program product of claim 11, further comprising code means for prioritizing the corrective action sequence based at least in part on the external database when the problem has been previously encountered.

13. The computer program product of claim 10, further comprising code means for analyzing the external database to determine a characteristic selected from the frequency of various failure modes and the efficiency of the corrective action in resolving failures.

14. A data processing system including processor, storage medium, and I/O means, the system including:
computer code means for performing diagnostic processing responsive to an indication of a system failure;
computer code means for performing corrective action resolving the failure; and
computer code means for generating a trouble ticket identifying the system, characterizing the failure, and identifying the correcting action taken and the success of the corrective action.

15. The data processing system of claim 14, wherein the storage medium of the data processing system includes an operational partition and a diagnostic partition, wherein the diagnostic partition includes the diagnostic processing code.

16. The data processing system of claim 14, further comprising, code means for forwarding the trouble ticket to a local database and an external database, and wherein the diagnostic processing code means includes code means for accessing at least one of the external or local databases to determine previous occurrences of the system failure and for using the database information to guide the corrective action taken.

17. A data processing system maintenance service, comprising:
providing diagnostic processing code capable of taking corrective action;
enabling the system to execute the diagnostic code in response to an indication of a system failure;
wherein, responsive to the corrective action resolving the system failure, the diagnostic code generates a trouble ticket including information indicative of the system, the system failure, and the corrective action and forwards the trouble ticket to an external database to enable the database to monitor the frequency, characteristics, and corrective action associated with locally resolved system failures.

18. The data processing system maintenance service of claim 17, wherein the diagnostic code further stores the trouble ticket in a local database.

19. The data processing system maintenance service of claim 17, wherein providing diagnostic code is further characterized as:
partitioning the system into at least two partitions including a diagnostic partition including the diagnostic processing code; and
booting the diagnostic partition responsive to the indication of the system failure.

20. The data processing system maintenance service of claim 17, wherein the corrective action is selected from a list including: rebooting the system, downloading software drivers, restoring the system to a last known good state, and accessing a database containing information indicative of previous system failures and corrective actions.
